(19) United States
(12) Patent Application Publication
(10) Pub. No.: US 2005/0253834 A1
(43) Pub. Date: Nov. 17, 2005

(54) Display apparatus and display system

(75) Inventors: Teruo Sakamaki, Tokyo-To (JP); Masachika Watanabe, Tokyo-To (JP)

Correspondence Address: OLIFF & BERRIDGE, PLC, P.O. BOX 19928, ALEXANDRIA, VA, 22320, US

(73) Assignee: Dai Nippon Printing Co., Ltd., Shinjuku-ku (JP)

(21) Appl. No.: 11/035,052

(22) Filed: Jan. 14, 2005

(30) Foreign Application Priority Data
Jan. 15, 2004 (JP) 2004-008442

(51) Int. Cl. G09G 5/00

(52) U.S. Cl. 345/207

(57) ABSTRACT

A display apparatus 10 has a display screen 11 comprised of plurality of pixels displaying images based on image data, light sensors 14 to detect light entering the display screen 11 and arranged with display elements 13 to form the pixels, and compound imaging systems 20 comprised of imaging lenses 211 forming images of a subject in the light-receiving part of the light sensors 14. Images of a subject are output from the plurality of light sensors 14, and a signal processing circuit 35 synthesizes the image signals to generate image data. The image displayed by the display screen 11 is based on the image data output by the signal processing circuit 35.

### BACKGROUND OF THE INVENTION

1. Field of the Invention

The present invention relates to a display apparatus which displays images based on image data, and a display system.

2. Background Art

In recent years, displays have been developed to provide the viewer with a strong sense of nearness to a projected image. These virtual reality displays are required to display wide-view images on large-sized screens, at the same time the images must be of high resolution and density. Displaying wide-view images on a large screen provides the width and depth needed to increase the realism of the image. In this way, the space of the image and the space of the viewer merge, with the effect that the viewer is drawn into the space of the image.

As types of virtual reality displays, there are a large-screen liquid crystal apparatus and a display apparatus to display 3D (three-dimensional) images. In the conventional method for producing an image of a subject, when creating the parallax images needed to generate a 3D image, conventionally slide cameras, rotating cameras, or a plurality of cameras arranged at multiple points have been used. Typically, instead of using multiple cameras, one camera is used by moving the camera right and left and up and down, or the subject itself is moved and 500-1,000 frames of the image are shot, the parallax images obtained and a 3D image suitable for the display medium generated through necessary calculations (for example, Patent Document 1).

However, in moving the camera as explained above to generate the 3D image, there are problems such as the time axis and the need for space for the camera. These problems have made it particularly difficult for the technology to spread to households.

In addition, with a plurality of cameras arranged at multiple points, there are the difficulties in providing sufficiently large spaces between the cameras and in creating a low-cost system.

The display apparatus plays the central role in the home AV system, and as the size of display systems has been expanded in recent years, the display apparatus typically occupies a larger space and demand has grown for a display apparatus with more functions and which is easier to use.

With the advent of digital broadcasting, it is now possible to have two-way communication of information through the display apparatus, with viewers taking part in quiz shows, for example, or a television display apparatus which can connect with the Internet (broadband). With these types of display apparatus, the viewer can answer questions on the quiz program or access a selected website. In order to enter or select information through the display apparatus, the viewer might use a mouse with a wide selection range to specify a position on the display screen. However, it is typical for viewers of display apparatus to be seated far from the screen, watching the display from a sofa, for example, with a remote control unit in one hand. In this situation, using a mouse would not be convenient, as the viewer would need to have a space to use the mouse, etc. The viewer can use a keypad on the remote control to enter information by pressing the buttons, but this has a low operability because the options are limited.

There is an information input system made to solve the aforementioned problems by using a simple remote pointing device to point to a position on the display, which is entered into an information input system (see Patent Document 2).

However, with this information input system, at least two coordinates from the pointing device pointed towards the display screen must be determined three-dimensionally based on the arrival time of sound or other types of elastic waves, and the position on the display calculated and input. In other words, since the position pointed to on the screen is input indirectly, the precision is low.

With displays used for television phones, a camera and microphone are arranged near the display screen, and images and sounds from these devices are sent to the opposite party. With these television phones, however, when the two parties are watching each other's image as they speak, the displayed image of the other party is not a normal and accurate image. There is also the problem that the speaker cannot see the image and expression of the other party properly if he is looking at the camera.

Patent Document 1: JP Patent Laid-Open Publication 2000-66568

Patent Document 2: JP Patent Laid-Open Publication 9-212288.

### SUMMARY OF THE INVENTION

The present invention provides for a display apparatus and display system with multiple functions and high operability, able to generate and display three-dimensional images.

The present invention is able to resolve the problems previously noted through the following means.

The display apparatus of the present invention comprises a display screen comprising a plurality of pixels, each of which includes a display element to display an image based on image data, and a wave transmission detection means for detecting outside electromagnetic waves or elastic waves transmitted to a plurality of different regions of the display screen.

In the display apparatus of the present invention, the wave transmission detection means includes wave detection elements in a plurality of the pixels or all the pixels of the display screen to detect the electromagnetic waves or the elastic waves, each being arranged together with the display element to form the pixel.

In the display apparatus of the present invention, the pixels of the display screen are arranged in a matrix, and each wave detection element of the wave transmission detection means forms a pair together with the display element in the pixel.

In the display apparatus of the present invention, the wave transmission detection means is comprised of a compound imaging system including photoelectric conversion elements to photoelectrically convert incident light, and a lens array to form an image of a subject in the photoelectric conversion element from the light transmitted to the display screen.

In the display apparatus of the present invention, the compound imaging system has a plurality of optical blocks corresponding to the plurality of different regions of the display screen, and each optical block forms the image of a subject in the corresponding photoelectric conversion elements from the outside light transmitted to the regions of the display screen.

In the display apparatus of the present invention, the plurality of photoelectric conversion elements corresponding to the optical blocks are provided in a plurality of the pixels or in all of the pixels, each being arranged together with the display element to form the pixel.

In the display apparatus of the present invention, the lens array of the compound imaging system has a plurality of lenses, each of the plurality of lenses being arranged substantially in a matrix, or each of the lenses being arranged so as to form the image of a subject from the subject facing the display screen in a center of the corresponding photoelectric conversion element.

In the display apparatus of the present invention, the plurality of lenses are angled with respect to the display screen so as to form the image of a subject in a center of the corresponding photoelectric conversion element.

In the display apparatus of the present invention, each of the optical blocks includes a restriction means to restrict an amount of light entering the optical blocks.

The display apparatus of the present invention further comprises an image data generation means for combining an image signal of an image of a subject output from each of the plurality of photoelectric conversion elements corresponding to each optical block so as to generate image data, wherein the pixels of the display screen display images based on the image data generated by the image data generation means.

In the display apparatus of the present invention, the image data generation means generates image data of a three-dimensional image, and the three-dimensional image is displayed on the display screen based on the image data generated by the image data generation means.

The display apparatus of the present invention further comprises a distance determination means to determine a distance from the display screen to the subject facing the display screen based on the image signals of the image of a subject output from each of the photoelectric conversion elements corresponding to each of the optical blocks.

In the display apparatus of the present invention, the image data generation means combines the image signals of the image of a subject output from each of the photoelectric conversion elements corresponding to each of the optical blocks so as to generate the image data in correspondence with the distance determined by the distance determination means.

The display apparatus of the present invention further comprises an indication position determination means to determine, based on detection results of the wave transmission detection means, a position of a displayed image on the display screen indicated by a viewer.

In the display apparatus of the present invention, indication position information indicating the position detected by the indication position determination means is displayed on the display screen.

The display apparatus of the present invention further comprises a position determination means to determine, based on detection results of the wave transmission detection means, a position of a source sending electromagnetic waves or elastic waves transmitted to the display screen.

In the display apparatus of the present invention, the position determination means determines the position of the viewer viewing the image on the display screen.

A display system according to the present invention comprises a display apparatus, a viewer operation apparatus including a wave transmission means to transmit electromagnetic waves or elastic waves from a position of a viewer to the display screen of a display apparatus based on the operation of the viewer viewing a display of a display apparatus, wherein the display apparatus includes a display screen comprising a plurality of pixels, each of which includes a display element to display an image based on image data, and a wave transmission detection means for detecting outside electromagnetic waves or elastic waves transmitted to a plurality of different regions of the display screen.

The display apparatus and display system according to the present invention provides the following advantageous effects:

(1) The wave transmission detection means detects outside electromagnetic waves or elastic waves transmitted to a plurality of different regions of the display screen, and based on the results of this detection, various functions of the display screen can be realized and its operability improved, such as imaging, detection of positions on the display screen indicated by the viewer, the detection of the position of the source of electromagnetic or elastic waves, etc.

(2) In particular, since the wave transmission detection means includes wave detection elements in each of the pixels of the display screen arranged together with the display element, the electromagnetic waves or elastic waves being transmitted to the display screen can be detected precisely. In addition, this enables the detection of electromagnetic waves or elastic waves transmitted to a distant pixel simply according to the size of the display screen.

(3) By connecting together the pair of the wave detection element and display element, with a gate electrode line, a source electrode line, and other parts, the display element and other constituent elements to realize the display features can be used to also make up the constituent elements for the detection features.

(4) By providing a lens array and photoelectric conversion elements, an image signal for the subject facing the display screen can be obtained.

(5) By having a compound imaging system with a plurality of optical blocks, the imaging system can be made thinner in the direction of light propagation, which can restrain the thickness of the display screen itself. In addition, a plurality of parallax images can be obtained.

(6) Since the plurality of photoelectric conversion elements corresponding to the optical blocks are provided in a plurality of the pixels together with the display element, a greater number of parallax images can be obtained.

(7) Since a lens array is used for the compound imaging system, the structure of the system is simple and the manufacturing cost can be restrained. In addition, the lens array is arranged so as to form an image of the subject facing the display screen in a center of the corresponding plurality of photoelectric conversion elements, and as a result, this prevents the image of a subject formed by the lens from being away from the light-receiving parts of the photoelectric elements.

(8) Since the lenses are angled with respect to the display screen, the image of a subject formed by the lens can be prevented from being away from the center of the light-receiving parts of the photoelectric elements.

(9) By having a restriction means, a scope of the image of a subject formed in the photoelectric conversion element can be restricted.

(10) Since the image data generation means combines image signals from the plurality of photoelectric conversion elements, higher resolution image data can be obtained, and in general, desired image data can be obtained.

(11) Since the image data generation means generates image data of a three-dimensional image, it is easy to generate and display three-dimensional images, which improves the feasibility of such a display apparatus for households.

(12) By having a distance determination means to determine a distance to the subject, the imaging and other functions can be improved.

(13) Since the image data generation means generates the image data in correspondence with the distance determined by the distance determination means, the parameters for creating the image data are increased, and the precision of the generated image data can be improved.

(14) Since the indication position determination means determines a position of a displayed image indicated by a viewer based on detection results of the wave transmission detection means, the viewer can easily indicate a position on the display screen.

(15) Since the indication position information is displayed on the display screen, the indicated position is notified to the viewer, improving the operability of the display apparatus for the viewer.

(16) Since a position determination means determines a position of a source sending electromagnetic waves or elastic waves transmitted to the display screen, for example, the image data generation means can generate image data corresponding to this position, and the precision of data can be improved.

(17) Since the position determination means determines the position of the viewer viewing the image on the display screen, the display screen can display an image suitable for the position of the viewer, and the image data generation means can generate image data to correspond with the viewer as the focal point.

(18) Since the viewer operation apparatus can send electromagnetic waves or elastic waves based on an operation of the viewer, the viewer can remotely operate the display apparatus.

### DESCRIPTION OF THE DRAWINGS

FIGS. 1(a) and 1(b) are views showing a display apparatus according to a first embodiment of the present invention.

FIG. 2 is a circuit diagram of a connection image of a display element and a light sensor.

FIG. 3 is a layered perspective view of the structure of a compound imaging system of the display apparatus.

FIG. 4. is a block diagram of the circuit structure of the display apparatus of the present invention.

FIG. 5 is a flowchart showing the process of generating a 3D image by image-based rendering.

FIGS. 6(a)(b)(c) are views showing a display apparatus according to the second embodiment.

FIG. 7 is a view showing a viewer operation apparatus of a display system of the present invention.

### DETAILED DESCRIPTION OF THE INVENTION

A display apparatus and display system which can generate and display three-dimensional images easily and which are multifunctional and have high operability, comprise a display screen to display an image including a plurality of display elements forming pixels of the display screen, photoelectric conversion elements arranged together and connected with the display elements to detect light entering the pixels of the display screen, a lens array corresponding to the plurality of photoelectric conversion elements to form a an image of a subject, and an image data generation means to combine image signals of the image of a subject output from each of the photoelectric conversion elements and generate image data.

### First Embodiment

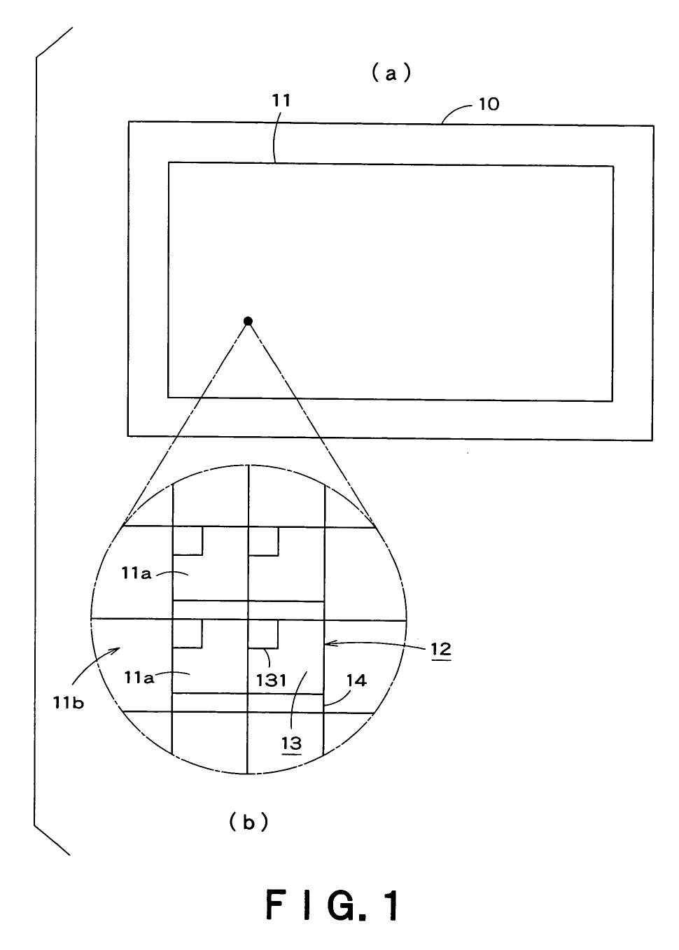

FIG. 1 shows a display apparatus according to embodiment 1 of the present invention. FIG. 1(a) is a front view of the display apparatus and FIG. 1(b) is a perspective view of a part of FIG. 1(a).

A display screen 10 has both a color display function and a color imaging function.

As shown in FIG. 1, the display apparatus 10 has a large 100-inch display screen 11 comprised of a plurality of pixels 11b, for example, 1080 pixels high and 1920 pixels wide (1.2 m×2.2 m). The display screen 11 has two plastic substrates filled with liquid crystal (or glass substrates, but if the display screen 11 of the display apparatus 10 is large in size, plastic substrates are preferable). The display apparatus 10 uses an active matrix-driven display in which striped-shaped electrodes are arranged in a cross pattern so that the pixels form a matrix.

The display apparatus 10 also has display imaging modules 12 formed in each of a plurality of sub-pixels 11a. Each display imaging module 12 comprises a display element 13 formed of a TFT (Thin Film Transistor) 131 and a condenser 132, and a photoelectric conversion element formed of a light sensor 14. The TFT 131 and the light sensor 14 are made of amorphous silicon, polysilicon, single crystal silicon, or another similar material.

The driving means, display element, and light sensor are not limited to those explained above. The pixel 11b is divided into three sections, each section including a color filter allocated for displaying one of three colors (RGB), and each section is referred to as the sub-pixel 11a. Therefore, the display apparatus 10 has display imaging modules-equal to three times the number of pixels 11b. With respect to the method of allocating the three colors to sub-pixel 11a, a variety of different patterning methods can be used, including the Bayer pattern method.

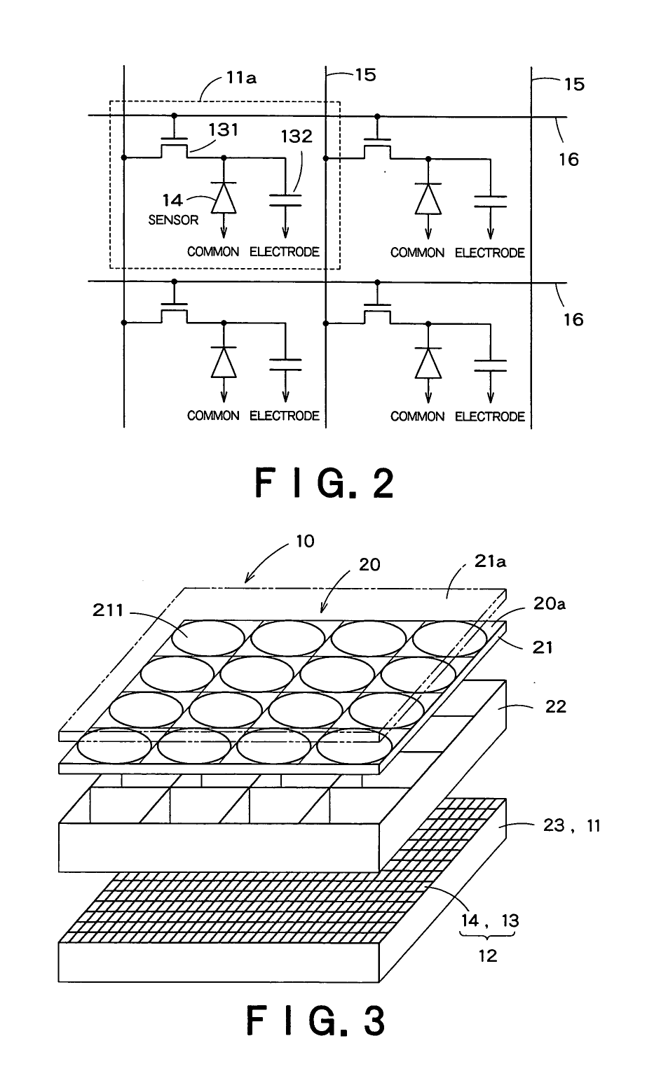

FIG. 2 shows the connection between the display element 13 and the light sensor 14. FIG. 2 shows the sub-pixel 11a in a 2×2 arrangement, with the longitudinal lines in a matrix pattern representing source electrode lines 15 connected to each of the sources electrodes of the TFT, and the latitudinal lines representing gate electrode lines 16 connected to each of the gate electrodes.

As shown in FIG. 2, the TFT 131, light sensor 14, and condenser 132 are arranged together in each sub-pixel 11a. The drain electrode of the TFT 131 is connected to the condenser 132 and light sensor 14 (photoelectric light conversion element) via the display electrode in order to supply voltage to the liquid crystal or light conducting film filling the two glass substrates (plastic substrates are preferable if the display screen 11 of the display apparatus 10 is large in size). The condenser 132 and the light sensor 14 are connected, via the liquid crystal or other medium, to a common electrode on the glass substrate facing the display electrode. When light enters the light sensor 14, a charge accumulated in the condenser 132 is discharged in accordance with a photoelectric current proportionate to the amount of light. The gradient of a given pixel can be detected from the speed of discharge.

FIG. 3 is a layered perspective view of the structure of a compound imaging system of the display apparatus.

As shown in FIG. 3, the display apparatus 10 comprises the display screen 11, a compound optical system including a lens array 21 stacked in layers parallel to the display screen 11, and a compound imaging system 20 including a light shield 22. In addition, the light sensor 14 is arranged in the sub-pixel 11a to form a light sensor array 23. In FIG. 3, the compound imaging system 20 is comprised of a plurality of optical blocks 20a.

The lens array 21 has a plurality of imaging lenses 211 which are arranged in longitudinal and latitudinal directions on a surface substantially parallel to the display screen 11. The imaging lens 211 form an image of a subject in a corresponding plurality of light sensors 14 of the light sensor array 23 from the outside light transmitted to the display screen 11, via the light shield 22. The image of a subject formed in the light-receiving part of the light sensor 14 by each imaging lens 211 has parallax corresponding to a position of the imaging lens 211. In other words, at its smallest, the parallax is the distance between the centers of two imaging lenses 211, and at its largest, the parallax is the distance between the opposite edges of the display screen 11.

The light shield 22 is arranged in a grid pattern between the lens array 21 and the corresponding plurality of light sensors 14 to prevent dispersion of light signals such as the light entering each imaging lens 211.

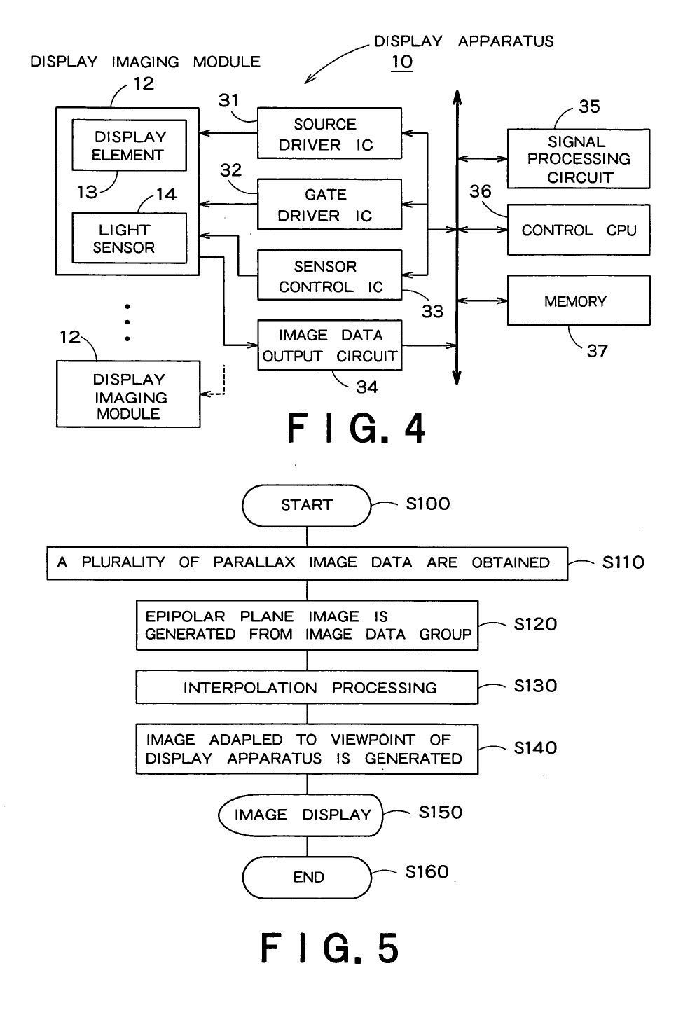

The plurality of light sensors 14 corresponding to the imaging lenses 211 convert the optical signals of the image of a subject into image signals and output the image signals to an image data output circuit 34 (see FIG. 4). A plurality of light sensors 14 and one grid part of the light shield 22 correspond to one imaging lens 211 to comprise a group which forms one optical block 20a. Each optical block 20a generates an image signal for an image having parallax. The foregoing description assumes the compound imaging system 20 comprises 16 optical blocks 20a (4×4) divided according to the division of the light shield 22, but the number of optical blocks 20a is not limited to this number and a plurality of optical blocks 20a may be arranged to correspond to the plurality of lights sensors 14.

FIG. 4. is a block diagram of the circuit structure of the display apparatus of the present invention.

The display apparatus 10 has a glass substrate liquid crystal panel forming the display screen 11, and on the frame of the glass substrate, there are a source driver IC31, a gate driver IC 32, a sensor control IC33, and the image data output circuit 34. Connected to these circuits via a bus are a signal processing circuit 35, a control CPU 36, and a memory 37.

The memory 37 is a hard disk or other memory device to store the image data output by the image data output circuit 34 and image data generated by the signal processing circuit 35. The control CPU 36 comprehensively controls the entire display apparatus 10.

The source driver IC 31 and the gate driver IC 32 are connected to the source electrode line 15 and the gate electrode line 16, respectively. The source driver IC 31 and the gate driver IC 32 supply voltage at a prescribed timing to each electrode line based on instructions from the control CPU 36. This drives each of the display elements 13 to display an image on the display screen 11.

The sensor control IC33 charges the condenser 132, sends photoelectrically converted image signals from the light sensors 14 to the image data output circuit 34, and controls the operation of the light sensors 14 in accordance with instructions from the control CPU 36 in order to input signals. The image data output circuit 34 converts the analog image signals output from the light sensors 14 into digital data, serializes the data, and after converting image signals according to a suitable process, writes the image signals to the memory 37.

The signal processing circuit 35 performs a prescribed processing of the plurality of parallax images written to the memory 37 based on the image data. For example, the data can undergo a correlation operation, be synthesized, and one high-resolution ordinary image data can be generated (image data generation function). In addition, points corresponding to parts where the plurality of different image data overlap can be detected, each image data can be corrected, a correlation operation can be performed on a plurality of corrected data, and the image data synthesized. Further, image data for panorama images and other types of images with different aspects can be generated. In other words, one subject can be overlapped to obtain a plurality of imaged data, and through prescribed calculating operations, comparisons, synthesis, trimming and other processes, the desired image data can be obtained. The generated image data is then displayed on the display screen 11 in accordance with instructions from the control CPU 36.

The signal processing circuit 35 can generate three-dimensional images from the plurality of image data. The image-based rendering method is commonly used to generate 3D display images from a plurality of parallax images.

This method is described in FIG. 5. First, a plurality of parallax image data are obtained from a plurality of imaging blocks (S110). Then, an epipolar plane image is generated from the image data group (S120). Interpolation processing is performed (S130), and then an image adapted to the viewpoint of the display apparatus is generated (S140). The generated image is then displayed on the display screen 11 (S150, S160). For a detailed explanation of image-based rendering, see “3D Image Conference 2003, Development of 3D Camera for High-Density Directional Images,” by Hiroshi Yoshikawa and Yasuhiro Takaki (both of Tokyo University of Agriculture).

The display apparatus 10 may also have a passive-type distance image sensor (distance determination function) to allow the signal processing circuit 35 to calculate a distance to a subject based on a plurality of parallax images and the principle of triangulation. In the case where the subject is the viewer of the display apparatus 10, the signal processing circuit 35 can generate and display image data based on the position of the subject and perform various types of processing based on the calculated distance.

In this way, the display apparatus 10 including the compound imaging system 20 can obtain the image data of a viewer in front of the display apparatus 10. By easily taking images of the subject facing the display screen 11, television phone communication can be easily made without any unnatural feeling for the people operating the television phone. In addition, the display apparatus 10 according to the present invention can easily obtain a plurality of image data with parallax in reference to a direction along the display screen 11.

In addition, the light sensor 14 is arranged in each of the sub-pixels 11a and forms a pair with the display elements 13. The plurality of lenses 211 are arranged on substantially the same plane in the lens array 21 to form the compound imaging system 20. In this way, the imaging system can be formed thin in the direction of light propagation, which can restrain the increase in the thickness of the display apparatus 10. In addition, it is also possible to easily obtain a plurality of parallax images.

Since the compound imaging system 20 uses the lens array 21, its structure is simple and it can be manufactured at a low cost.

In addition, since the lights sensors 14 are provided so as to firm pairs with the display elements 13, and both arranged in each of the sub-pixels 11a, the gate electrode line 16, source electrode line 15 and other elements to perform the display functions can also be utilized to perform the detection functions.

The display apparatus 10 carries out prescribed processing using the signal processing circuit 35 based on a plurality of image data, and thereby the display apparatus 10 can generate high resolution images, determine a distance to a subject such as a viewer, and easily generate 3D image data for a high operability and convenience.

Further, image data can be generated by the signal processing circuit 35 in accordance with a determined distance, thereby increasing the parameters for generating image data and improving the precision of the generated image data.

### Second Embodiment

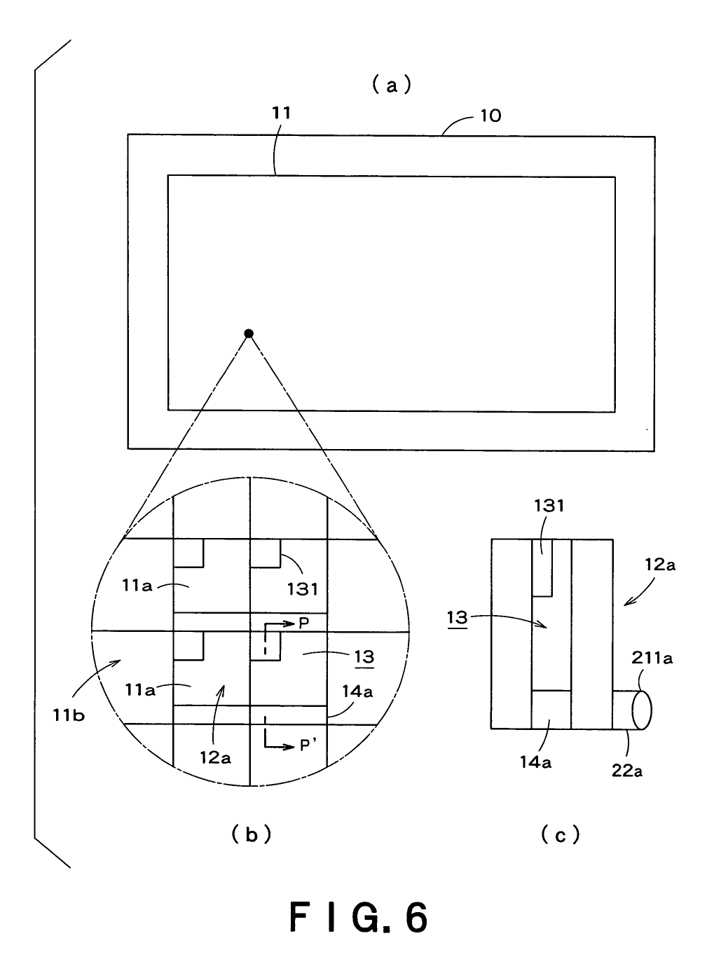

FIGS. 6(a)(b)(c) illustrate the present invention according to the second embodiment. FIG. 6(a) is a front view of the display apparatus, FIG. 6(b) is a perspective view of a part of FIG. 6(a), and FIG. 6(c) is a cross-sectional view of FIG. 6(b) along line P-P′.

The parts shown in FIGS. 6(a)-(c) have the same numerals as the parts shown in FIGS. 1-5, and therefore detailed explanation of the parts will be omitted.

As shown in FIGS. 6(a)(b)(c), the display apparatus 10 is the same size as in the first embodiment and formed of the same parts. The display screen 11 of the display apparatus 10 has display imaging modules 12a, each including imaging elements 14a. The display imaging module 12a is formed in each of the sub-pixels 11a. In addition, each of the display imaging modules 12a has an imaging lens 211a, which forms an image of the subject in a light-receiving part of imaging element 14a, and a light shield 22a, which prevents interference of light signals entering the imaging lenses 211a. In this way, the imaging lens 211a and light shield 22a are arranged in each of the sub-pixels 11a.

The imaging element 14a is composed of a plurality of minute light sensors arranged in a matrix on the same plane and corresponding to the imaging lenses 211a. This plurality of minute light sensors are arranged together with one display element 13 in each of the sub-pixels 11a of each of the pixels 11b. The imaging element 14a photoelectrically converts an image of a subject formed in the light-receiving part and outputs the signals to an image signal output circuit 34. The display apparatus 10 can thereby generate parallax image data in each of the sub-pixels 11a.

In the display apparatus 10 shown in FIG. 6(a)-(c), the parallax image data are obtained in each of the sub-pixels 11a. In other words, a large number of parallax images can be obtained. In addition, these parallax images are synthesized by a signal processing circuit 35 to generate higher resolution viewing images, while an accurate distance to the subject such as a viewer can be determined to generate more effective 3D image data. These effects improve the operability of the display apparatus 10.

(Modification of Embodiments)

The present invention is not limited to the first and second embodiments, and various modifications can be made within the scope of the present invention. For example, in each of the embodiments, the display apparatus 10 may include apertures 21a on the outside of the imaging lenses 211, 211a forming the optical blocks 20a, to restrict the amount of entering light (refer to FIG. 3). The apertures 21a are formed of a light-shielding plate material and the number of the apertures 21a corresponds to the number of imaging lenses 211, 211a, with the size of the openings corresponding to the size of each of the view regions of the imaging lenses 211, 211a. By using the apertures 21a, the scope of an image of a subject formed by the imaging lenses 211, 211a in the light-receiving part of the light sensors 14 or the imaging elements 14a can be limited.

In each of the first and second embodiments, the imagining lenses 211, 211a can be angled with respect to the display screen 11 and the lens array 21 so as to form an image of the subject facing the display screen 11 in the center of the light-receiving part of each of the light sensors 14 or the imaging elements 14a. In this way, even if the subject is near the display screen 11, a precise image of the subject can be formed by the imaging lenses 211, 211a in the light-receiving part of the light sensors 14 or the imaging elements 14a.

The imaging lenses 211, 211a are disposed just above the light sensors 14 or imaging elements 14a in order to face opposite the light-receiving part of the light sensors 14 or the imaging elements 14a. However, the imaging lenses 211, 211a forming the images of the subject in the light sensors 14 or the imaging elements 14a corresponding to the outer region of the display screen 11 may be disposed somewhat inside the light sensors 14 or the imaging elements 14a to form images of the subject in the center of the light-receiving part of the light sensor 14 or the imaging element 14a.

In both of the first and second embodiments, the display apparatus 10 has a 100-inch display screen 11, but the size of the screen is not limited to 100 inches as long as a plurality of image data with different input parameters can be obtained. The larger the size of the screen, the stronger the sense of nearness to the displayed image, and image data with large parallax can be obtained. The same is true of the resolution (number of pixels) of the display screen 11.

The display apparatus 10 can also be incorporated into a digital camera in order to easily take an image of the subject operating the camera.

In both of the first and second embodiments, the signal processing circuit 35 can synthesize generated image data of a subject such as a viewer with data prerecorded in the memory 37. For example, as in the “purikura” (registered trademark) imaging system, background images can be prerecorded in the memory 37 and synthesized with image data of the viewer by the signal processing circuit 35 and displayed on the display screen 11. With the viewer's line of vision facing the display screen 11, a normal image of the viewer can be obtained to give the display screen 11 a mirror function. In this way, a mirror-like image of the viewer can be taken, and a user could, for example, display their own image wearing clothing prerecorded in the memory 37.

In the same way, a viewer could prerecord favorite hairstyles or hairstyles downloaded from the Internet or other sources onto the memory 37 and simulate their own figures with the different prerecorded hairstyles and then record the simulated images on an IC memory media, removable disk or some other portable information recording media. When the viewer goes for a haircut, for example, they could transfer the image data from their portable device to a display apparatus 10 at the hair styling or barber shop, display their desired haircut, and then ask for a similar haircut. In another usage, the user could download information on methods of applying cosmetics and simulate the application using the image data prerecorded in the memory 37.

In both the first and second embodiments, the display screen 10 has light sensors 14 or imaging elements 14a to detect light transmitted from the outside to the display apparatus 11. The light sensors 14 or imaging elements 14a form a wave transmission detection means to detect transmitted waves. The object of detection, however, is not limited to light. The display screen 10 can have sensors to detect electric waves with a longer wavelength and lower frequency than light or any other such electromagnetic waves with a band frequency, or sensors to detect elastic waves such as sound waves or ultrasonic weaves. For example, instead of light sensors 14 or imaging sensors 14a, the display screen 10 can include sensors to detect the voice (sound waves) of the viewer, and the sound wave sensors can be arranged on the entire display apparatus 11. The pathway difference of the sound waves detected by each of the sound wave sensors can be determined based on the difference in time of determination (sound wave arrival time difference), and then the position of the viewer with respect to the screen can be determined by the signal processing circuit 35.

If a viewer is operating a laser pointer, the laser pointer light transmitted at a prescribed frequency can be detected by the light sensors 14 or imaging elements 14a, and the position on the display screen to which the viewer is pointing can be directly determined by the signal processing circuit 35. In this case, information selected by the viewer can be easily inputted, much like using a PC mouse. In addition, in the case of using a pointer that does not transmit visible light, the display screen can display on the display screen 11 the position indicated by using an icon or another means in order to inform the viewer of the indicated position.

Various types of electromagnetic or elastic waves can be utilized depending on their properties, with the viewer transmitting the waves towards the display screen 11, and by detection of the waves by the sensors of the display apparatus 10, the operability can be improved.

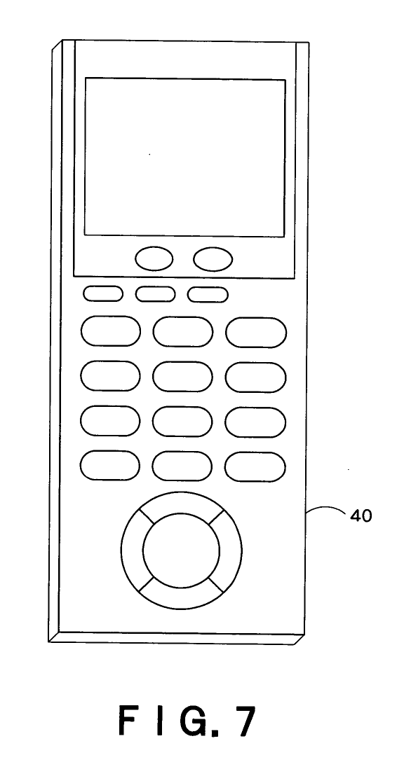

In the case that the display apparatus is used to display digital broadcasting, instead of the light sensors 14 or imaging elements 14a used to detect the instruction signals from a remote control 40 (wave transmission means) of a tuner or STB (Set Top Box) as shown in FIG. 7, sensors can be arranged on the entire display screen 11. In this case, the entire display screen 11 becomes a signal receiving part and the operability for the viewer is enhanced.

In both the first and second embodiments, the display apparatus 10 includes a light sensor 14 or imagining element 14a in each of the sub-pixels 11a. It is also possible, however, to have light sensors 14 or imaging elements 14a in only some of the sub-pixels 14a. For example, it is possible to arrange the light sensors 14 or imaging elements 14a in the sub-pixel 11a or the pixels 11b representing only the black part of a checkerboard pattern of pixels. The light sensors 14 or imaging elements 14a may also be arranged in the sub-pixels 11a forming a horizontal axis or vertical axis originating in the center of the display screen 11. In other words, the plurality of light sensors 14 or imaging elements 14a may be arranged to correspond to different regions of the display screen 11.

1. A display apparatus comprising,
a display screen comprising a plurality of pixels, each of which includes a display element to display an image based on image data, and
a wave transmission detection means for detecting outside electromagnetic waves or elastic waves transmitted to a plurality of different regions of the display screen.

2. The display apparatus according to claim 1, wherein
the wave transmission detection means includes wave detection elements in a plurality of the pixels or all the pixels of the display screen to detect the electromagnetic waves or the elastic waves, each being arranged together with the display element to form the pixel.

3. The display apparatus according to claim 2, wherein
the pixels of the display screen are arranged in a matrix, and
each wave detection element of the wave transmission detection means forms a pair together with the display element in the pixel.

4. The display apparatus according to claim 1, wherein
the wave transmission detection means is comprised of a compound imaging system including photoelectric conversion elements to photoelectrically convert incident light, and a lens array to form an image of a subject in the photoelectric conversion element from the light transmitted to the display screen.

5. The display apparatus according to claim 4, wherein
the compound imaging system has a plurality of optical blocks corresponding to the plurality of different regions of the display screen, and
each optical block forms the image of a subject in the corresponding photoelectric conversion elements from the outside light transmitted to the regions of the display screen.

6. The display apparatus according to claim 5, wherein
the plurality of photoelectric conversion elements corresponding to the optical blocks are provided in a plurality of the pixels or in all of the pixels, each being arranged together with the display element to form the pixel.

7. The display apparatus according to claim 4, wherein
the lens array of the compound imaging system has a plurality of lenses, each of the plurality of lenses being arranged substantially in a matrix, or each of the lenses being arranged so as to form the image of a subject from the subject facing the display screen in a center of the corresponding photoelectric conversion element.

8. The display apparatus according to claim 7, wherein
the plurality of lenses are angled with respect to the display screen so as to form the image of a subject in a center of the corresponding photoelectric conversion element.

9. The display apparatus according to claim 5, wherein
each of the optical blocks includes a restriction means to restrict an amount of light entering the optical blocks.

10. The display apparatus according to claim 5, further comprising:
an image data generation means for combining an image signal of the image of a subject output from each of the plurality of photoelectric conversion elements corresponding to each optical block so as to generate image data, wherein
the pixels of the display screen display images based on the image data generated by the image data generation means.

11. The display apparatus according to claim 10, wherein
The image data generation means generates image data of a three-dimensional image, and
the three-dimensional image is displayed on the display screen based on the image data generated by the image data generation means.

12. The display apparatus according to claim 10, further comprising:
a distance determination means to determine a distance from the display screen to the subject facing the display screen based on the image signals of the image of a subject output from each of the photoelectric conversion elements corresponding to each of the optical blocks.

13. The display apparatus according to claim 12, wherein the image data generation means combines the image signals of the image of a subject output from each of the photoelectric conversion elements corresponding to each of the optical blocks so as to generate the image data in correspondence with the distance determined by the distance determination means.

14. The display apparatus according to claim 1, further comprising:
an indication position determination means to determine, based on detection results of the wave transmission detection means, a position of a displayed image on the display screen indicated by a viewer.

15. The display apparatus according to claim 1, wherein
indication position information indicating the position detected by the indication position determination means is displayed on the display screen.

16. The display apparatus according to claim 1, further comprising
a position determination means to determine, based on detection results of the wave transmission detection means, a position of a source sending electromagnetic waves or elastic waves transmitted to the display screen.

17. The display apparatus according to claim 16, wherein
the position determination means determines the position of the viewer viewing the image on the display screen.

18. A display system, comprising:
a display apparatus,
a viewer operation apparatus including a wave transmission means to transmit electromagnetic waves or elastic waves from a position of a viewer to the display screen of a display apparatus based on the operation of the viewer viewing a display of a display apparatus, wherein
the display apparatus includes a display screen comprising a plurality of pixels, each of which includes a display element to display an image based on image data, and
a wave transmission detection means for detecting outside electromagnetic waves or elastic waves transmitted to a plurality of different regions of the display screen.
